(19) United States
(12) Patent Application Publication
(10) Pub. No.: US 2025/0298494 A1
(43) Pub. Date: Sep. 25, 2025

(54) METHOD, APPARATUS, DEVICE AND STORAGE MEDIUM FOR SHARING AUDIOVISUAL CONTENT

(71) Applicant: Beijing Zitiao Network Technology Co., Ltd., Beijing (CN)

(72) Inventors: Ke Li, Beijing (CN); Kang Zheng, Beijing (CN); Jinghui Liu, Beijing (CN); Jiafeng Shen, Beijing (CN); Zaofeng Pan, Beijing (CN); Shuran Wang, Beijing (CN); Tianhui Shi, Beijing (CN); Ze Geng, Beijing (CN); Wei Liu, Beijing (CN); Biao Gong, Beijing (CN)

(21) Appl. No.: 18/862,157

(22) PCT Filed: May 19, 2023
(86) PCT No.: PCT/CN2023/095265

§ 371 Date: Oct. 31, 2024

(30) Foreign Application Priority Data
Jun. 21, 2022 (CN) 202210707221.7

(51) Int. Cl. G06F 3/0484; G06F 3/0482; G11B 27/031; G11B 27/34

(52) U.S. Cl. CPC G06F 3/0484; G06F 3/0482; G11B 27/031; G11B 27/34

(57) ABSTRACT

According to embodiments of the disclosure, a method, an apparatus, a device and storage medium for sharing audiovisual content are provided. The method includes receiving a selection for a plurality of text fragments corresponding to a plurality of portions in target audiovisual content, the plurality of portions at least comprising a first portion and a second portion that are discontinuous in the target audiovisual content; causing fragmented audiovisual content to be created based at least on the plurality of portions in the target audiovisual content, wherein the first portion and the second portion are continuous in the fragmented audiovisual content; and presenting a sharing portal for sharing the fragmented audiovisual content. In this way, embodiments of the disclosure enable the merge sharing for discontinuous fragments in original audiovisual content (e.g., audio content or video content).

This application claims the priority to Chinese Patent Application No. 202210707221.7, filed on Jun. 21, 2022, and entitled “METHOD, APPARATUS, DEVICE, AND STORAGE MEDIUM FOR SHARING AUDIOVISUAL CONTENT”, which is incorporated herein by reference in its entirety.

### FIELD

Example embodiments of the present disclosure generally relate to the field of computers, and in particular, to methods, apparatuses, devices, and computer-readable storage medium for sharing audiovisual content.

### BACKGROUND

With the development of computer technologies, the Internet has become the main platform for people to obtain and share content. For example, people may use the Internet to publish a wide variety of content, or receive content shared by other users.

In Internet-based content sharing, sharing of audiovisual content (e.g., audio content or video content) has become one of the most dominant forms. People may, for example, share a video or audio recording of a speech or a conference with other users. However, such a speech or a conference typically has a long duration, which makes such an approach of sharing audiovisual content inefficient, making it difficult for the person being shared with to quickly and efficiently obtain desired information.

### SUMMARY

In a first aspect of the present disclosure, a method of sharing audiovisual content is provided. The method includes: receiving a selection for a plurality of text fragments corresponding to a plurality of portions in a target audiovisual content, the plurality of portions at least comprising a first portion and a second portion that are discontinuous in the target audiovisual content; causing fragmented audiovisual content to be created based at least on the plurality of portions in the target audiovisual content, wherein the first portion and the second portion are continuous in the fragmented audiovisual content; and presenting a sharing portal for sharing the fragmented audiovisual content.

In a second aspect of the present disclosure, an apparatus for sharing audiovisual content is provided. The apparatus includes a receiving module configured to receive a selection for a plurality of text fragments corresponding to a plurality of portions in a target audiovisual content, the plurality of portions at least comprising a first portion and a second portion that are discontinuous in the target audiovisual content; a control module configured to cause fragmented audiovisual content to be created based at least on the plurality of portions in the target audiovisual content, wherein the first portion and the second portion are continuous in the fragmented audiovisual content; and a presentation module configured to present a sharing portal for sharing the fragmented audiovisual content.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The medium stores a computer program, and when the program is executed by the processor, the method of the first aspect is implemented.

It should be understood that the content described in the summary part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numerals refer to the same or similar elements, where:

FIG. 1 illustrates a schematic diagram of an example interface of conventional audiovisual content sharing;

FIGS. 2A-2B illustrate schematic diagrams of example interfaces for selecting text fragments according to some embodiments of the present disclosure;

FIGS. 3A-3C illustrate schematic diagrams of example interfaces for selecting text fragments according to other embodiments of the present disclosure;

FIG. 4 illustrates a schematic diagram of an example sharing portal according to some embodiments of the present disclosure;

FIG. 5 illustrates a schematic diagram of sharing fragmented audiovisual content in a session according to some embodiments of the present disclosure;

FIG. 6 illustrates a schematic diagram of a viewing interface of fragmented audiovisual content according to some embodiments of the present disclosure;

FIG. 7 illustrates a schematic diagram of a management interface of fragmented audiovisual content according to some embodiments of the present disclosure;

FIG. 8 illustrates a schematic diagram of a management interface of fragmented audiovisual content according to other embodiments of the present disclosure;

FIG. 9 illustrates a flowchart of an example process of sharing audiovisual content according to some embodiments of the present disclosure;

FIG. 10 illustrates a block diagram of an apparatus for sharing audiovisual content according to some embodiments of the present disclosure; and

FIG. 11 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and similar terms should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below.

As discussed above, with the development of Internet technologies, people increasingly utilize the Internet to share audiovisual content, such as videos or audios. Such audiovisual content sharing techniques are particularly important in scenarios such as online conference, remote education, online lecture or open class, etc.

For example, it would be desirable to be able to record content of a conference, presentation, or online class through video or audio, and share such recorded content (e.g., audio or video) to other users.

Conventional audiovisual content sharing techniques typically only allow users to share all audiovisual content. In some cases, however, such conferences, classes, presentations typically have a longer duration, while in some sharing scenarios, some of the content in the conference may be preferred to be shard. This causes the conventional solution for sharing audiovisual content to be inefficient and difficult to meet the needs of people to share some part of audiovisual content.

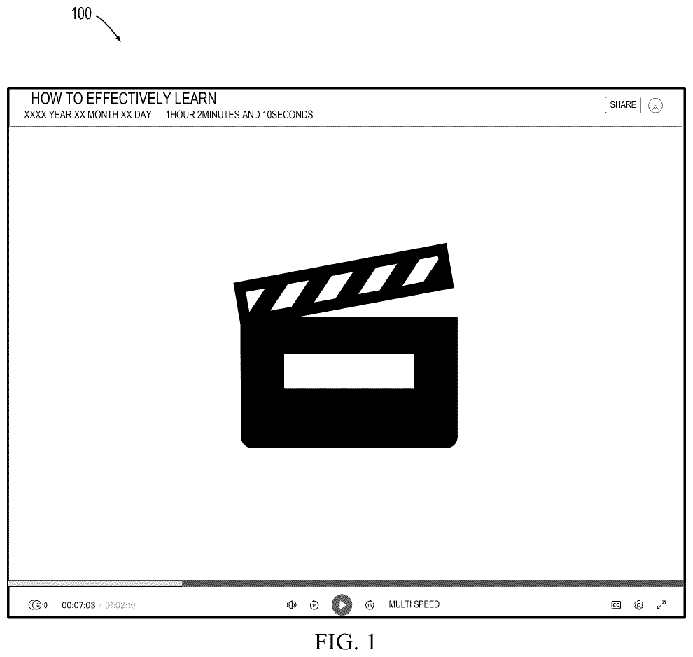

For example, FIG. 1 illustrates a schematic diagram of an example interface 100 for conventional audiovisual content sharing. The interface 100 may be, for example, a video sharing for the video conference “How to effectively learn”. It can be seen that such the video sharing content has a duration of “1 hour 2 minutes and 10 seconds”, which makes it difficult for some people being shared with to quickly obtain their desired information.

Embodiments of the present disclosure provide a solution for sharing audiovisual content (e.g., audio content and/or video content). In this solution, a selection for a plurality of text fragments (e.g., transcribed text fragments of a speaker in a conference) may be received, where the plurality of text fragments correspond to a plurality of portions in target audiovisual content, and the plurality of portions at least include a first portion and a second portion that are discontinuous in the target audiovisual content.

Further, fragmented audiovisual content may be caused to be created based at least on the plurality of portions in the target audiovisual content, where the first portion and the second portion are contiguous in the fragmented audiovisual content. Accordingly, a sharing portal for sharing the fragmented audiovisual content may be presented.

On the basis of such a mode, on one hand, embodiments of the present disclosure may support the user to more efficiently share the fragmented audiovisual content by selecting the text fragment, so that the efficiency of sharing audiovisual content may be improved, and the efficiency of obtaining information by the person being shared with is improved.

In addition, the embodiments of the present disclosure also support the user in selecting discontinuous fragments to create, which further improves the flexibility of sharing the fragmented audiovisual content.

The following describes example solutions according to embodiments of the present disclosure in detail with reference to the accompanying drawings.

### Sharing Fragmented Audiovisual Content

In some embodiments, a portal to create and share fragmented audiovisual content may be provided by a viewing interface in original audiovisual content (also referred to as “target audiovisual content”).

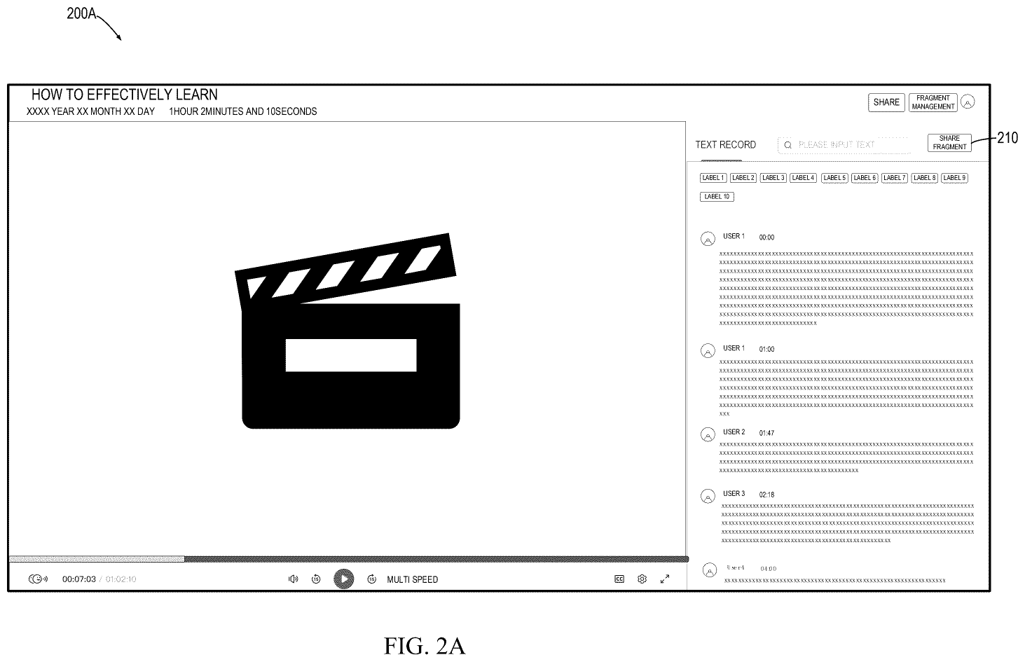

FIG. 2A illustrates an example interface 200A of sharing fragmented audiovisual content in accordance with some embodiments of the present disclosure. As shown in FIG. 2A, the interface 200A may be, for example, a viewing interface for the target audiovisual content “How to effectively learn”.

The interface 200A may be, for example, provided by an appropriate electronic device, and an example of such an electronic device may include, but is not limited to, a desktop computer, a laptop computer, a smart phone, a tablet computer, a personal digital assistant, or a smart wearable device, etc.

As shown in FIG. 2A, the target audiovisual content may be, for example, video content, the interface 200A may include a playback area for the video content and a text area “text record” (also referred to as a text interaction component) corresponding to the video content to present text corresponding to the video content.

In some embodiments, a plurality of independent text fragments may be presented in the text area. Such text fragments may be determined, for example, based on a speech transcription of the target audiovisual content. Taking FIG. 2A as an example, the plurality of text fragments may, for example, correspond to speech of speakers at different moments in the conference.

In some embodiments, the text area may also provide audio object information corresponding to the text fragment. Such audio object information may be used to indicate a speaker associated with the text fragment. For example, the audio object information may include an identifier (for example, “user 1”) of the speaker corresponding to the text fragment, or an avatar of the speaker.

In some embodiments, the browsing of the text fragments in the text area may be synchronized with the playing of the target audiovisual content. For example, the text area may adjust the presentation of the text fragment such that the presented text fragment corresponds to the portion of the target audiovisual content being played in time. Alternatively, the text area may further adjust a presentation style of the text fragment and/or some text in the text fragment, so that the text content corresponding to the portion of the target audiovisual content being played is highlighted. In addition, as the target audiovisual content is played, the text content highlighted in the text area may vary accordingly.

Alternatively, or additionally, the browsing of the text fragments in the text area may also be independent of the playing of the target audiovisual content. That is, the user may browse the text fragments in the text area during the playing of the target audiovisual content, for example, by operations such as dragging and the like.

It should be understood that while in the example of FIG. 2A, the target audiovisual content is shown as video content. In some cases, the target audiovisual content may also include audio content only. Correspondingly, the plurality of text fragments may also be determined based on a speech transcription of the audio content.

Further, while in the example of FIG. 2A, the target audiovisual content is shown as audiovisual recording for a conference. In some embodiments, the target audiovisual content may also include other forms. For example, the target audiovisual content may be a record of an online classroom or an online speech.

Alternatively, the target audiovisual content may also be other suitable forms of video or audio. For example, the target audiovisual content may also be movie content, and the plurality of text fragments may be, for example, dialogue content of characters in a movie.

### Selection of Text Fragment

In some embodiments, the interface 200A may include, for example, a sharing control 210. Upon receiving the selection for the sharing control 210, the electronic device may present an interface 200B for text fragment selection as shown in FIG. 2B. It should be understood that the interface 200B only shows a text area for ease of description.

As shown in FIG. 2B, for example, after the user clicks the sharing control 210, the electronic device may present selection controls 220-1 to 220-4 (individually or collectively referred to as a selection control 220) in association with text fragments 230-1 to 230-4 (individually or collectively referred to as a text fragment 230).

As shown in FIG. 2B, the selection control 220 may be in the form of a selection box, for example. The electronic device may receive a selection for the selection control 220 to determine whether the corresponding text fragment is selected.

In the example shown in FIG. 2B, the electronic device may receive selections for selection controls 220-1, 220-2, and 220-4 to determine that the corresponding text fragments 230-1, 230-2, and 230-4 are selected. It can be seen that the text fragment 230-2 and the text fragment 230-4 may, for example, correspond to discontinuous portions of the target audiovisual content.

Alternatively, the electronic device may also receive a selection for the “full selection” function and determine that all the fragments are in the selected state. Further, the electronic device may, for example, receive a cancel operation for the selection control 220-3, thereby canceling the selection for the text fragment 230-3.

In some embodiments, the interface 200B may also present a merging control 240. In an example, as shown in FIG. 2B, the merging control 240 may be, for example, a button that triggers a merging operation.

In some embodiments, the electronic device may also present a fragment time length through the merging control 240. The fragment time length may be, for example, a sum of time lengths of the audiovisual content portions corresponding to the selected plurality of text fragments.

In some embodiments, the fragment time length may be presented in real-time based on selection of the text fragments. Therefore, the fragment time length may be updated according to new text fragments being selected or the text fragment being deselected.

In some embodiments, the fragment time length may also be presented, for example, after receiving an acknowledgement for the selection of the plurality of text fragments. For example, the electronic device may provide a confirmation button after the user clicks the plurality of text fragments, and after receiving a click on the confirmation button, present a fragment time length corresponding to the plurality of text fragments.

In some embodiments, activation of the merging control 240 may be used to trigger a merging device to create the fragmented audiovisual content based on the target audiovisual content and the selected plurality of text fragments (e.g., text fragments 230-1, 230-2, and 230-4).

In some embodiments, the electronic device may cause the merging control 240 to be in an activatable state only if it is determined that the fragment time length is less than a threshold length. Such a threshold length may, for example, correspond to the time length of the target audiovisual content to prohibit the user from selecting all fragments for sharing. Alternatively, the threshold length may also be a predetermined time length. In this way, the user can be prevented from creating an excessively lengthy fragment through the function of sharing fragmented audiovisual content sharing.

The selection of the text fragment is triggered by the activation of the selection control 210. In some embodiments, the electronic device may, for example, also support selection of the text fragment based on other manners.

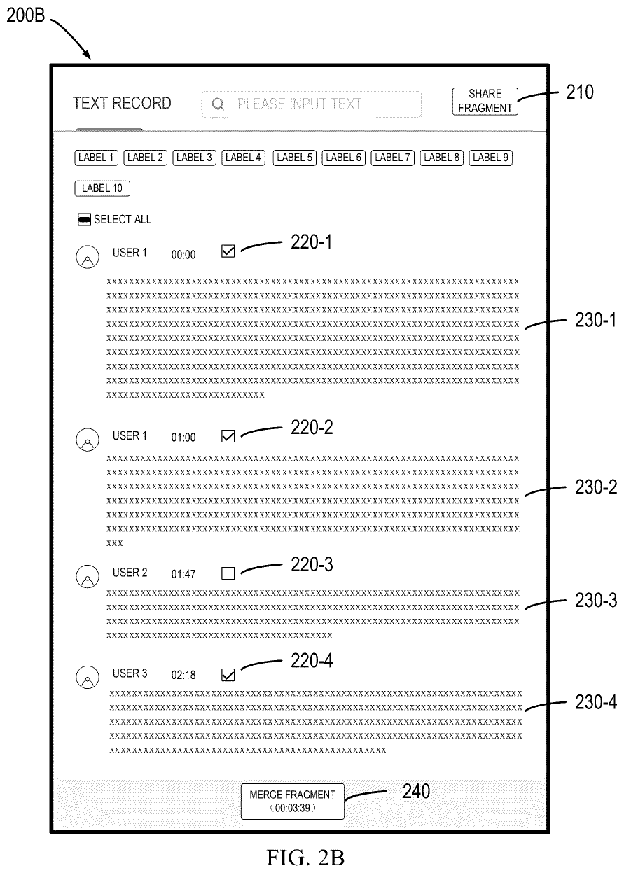

FIGS. 3A-3C illustrate schematic diagrams of example interfaces for selecting text fragments according to other embodiments of the present disclosure. For ease of description, FIGS. 3A to 3C only illustrate a text presentation area of the interface.

As shown in FIG. 3A, when a selection operation for the text fragment 330-1 is detected, the electronic device may present a selection control 320-1 associated with the text fragment 330-1 in the interface 300A. Examples of such a selection operation may include appropriate forms of operations, such as a hover operation, a single-click operation, a double-click operation, a slide operation, a drag operation, a long-press operation, and the like. In some embodiments, taking the hover operation as an example, such a hover operation may include a hover based on a mouse or cursor (e.g., cursor 340) and/or a hover based on a touch device (e.g., finger, stylus), etc.

Further, as shown by the interface 300B, upon receiving a selection operation for the selection control 320-1, the electronic device may further present selection controls (e.g., selection controls 320-2, 320-3, and 320-4) corresponding to other text fragments (e.g., text fragments 330-2, 330-3, and 330-4). Therefore, fragment selection and sharing may be quickly entered without activating the sharing control 310.

In some embodiments, as shown in the interface 300B, the electronic device may also present a merging control 350 and present a fragment time length.

Further, as shown in the interface 300C, the electronic device may receive selections for the selection control 320-2 and the selection control 320-4, and correspondingly determine that the corresponding text fragment 330-2 and the text fragment 330-4 are also selected. Accordingly, the fragment time length in the merging control 350 may be updated correspondingly.

Similar to the merging control 240 discussed with reference to FIG. 2B, activation of the merging control 350 may be used to trigger the merge device to create the fragmented audiovisual content based on the target audiovisual content and the selected plurality of text fragments (e.g., text fragments 330-1, 330-2, and 330-4).

In some embodiments, the electronic device may cause the merging control 350 to be in an activatable state only if it is determined that the fragment time length is less than a threshold length. Such a threshold length may correspond to, for example, a time length of the target audiovisual content, or may be a predetermined time length. In this way, the user may be prevented from creating an excessively lengthy fragment through the function of sharing fragmented audiovisual content.

In some embodiments, the electronic device may also support the user to quickly select one or more text fragments by a speaker. In an example, the electronic device may, for example, receive an input of the user with respect to a target speaker, and automatically select all text fragments associated with the target speaker. Alternatively, the electronic device may also filter out all text fragments associated with the target speaker based on the input of the user with respect to the target speaker for further selection by the user. In this way, the embodiments of the present disclosure can further improve flexibility of text fragment selection.

It should be understood that while the above examples describe the selection of multiple text fragments (and including discontinuous text fragments), embodiments of the present disclosure also support the user in selecting only one text fragment for sharing or support the user in selecting multiple continuous text fragments for sharing.

### Creation of Fragmented Audiovisual Content

In some embodiments, after selecting the plurality of text fragments based on the solution discussed above, the electronic device may trigger the merging device to create the fragmented audiovisual content. In some embodiments, the merging device may be the same or a different device as the electronic device.

For example, the electronic device may be a terminal device of the user, and the merging device may be, for example, a cloud server device. Therefore, the computation overhead of the terminal device for the user may be reduced. Alternatively, the merging device may also be implemented by the terminal device of the user.

Taking the merging device being a device different from the electronic device as an example, the electronic device may send merging time information to the merging device to trigger the merging device to create the fragmented audio-visual content. Specifically, the merging time information, for example, indicates times of a plurality of portions corresponding to the selected plurality of text fragments in the target audiovisual content.

In an example, the electronic device may determine that the time corresponding to the text fragment 330-1 is “00:00-01:00”, the time corresponding to the text fragment 330-2 is “01:00-01:47”, and the time corresponding to the text fragment 330-4 is “03:18-04:00”.

Further, the merging device may create the fragmented audiovisual content based on the merging time information and the target audiovisual content.

In some embodiments, the fragmented audiovisual content may have the same format as the target audiovisual content. For example, the target audiovisual content may be, for example, video content, and the created fragmented audiovisual content may also be video content.

For example, the merging device may extract a plurality of fragments in the target audiovisual content based on the received merging time information and stitch these fragments into a new fragmented audiovisual content.

In some embodiments, the fragmented audiovisual content may also have a different format than the target audiovisual content. For example, the target audiovisual content may be, for example, video content, and the created fragmented audiovisual content may be audio content.

Accordingly, the merging device may extract a plurality of audio fragments in the target audiovisual content (e.g., video content) based on the received merging time information and stitch these fragments into a new fragmented audiovisual content (e.g., audio content).

It should be understood that although the creation process of the fragmented audiovisual content is described above by using the merging device and the electronic device as an example, the electronic device may also construct the fragmented audiovisual content based on a similar solution locally, which will not be described in detail herein.

### Example Sharing Portal

In some embodiments, after the creation of the fragmented audiovisual content is completed, the electronic device may further provide a sharing portal for sharing the fragmented audiovisual content.

In some embodiments, the sharing portal may include prompt information to indicate that the fragmented audiovisual content has been created and that a link for accessing the fragmented audiovisual content has been replicated in a clipboard.

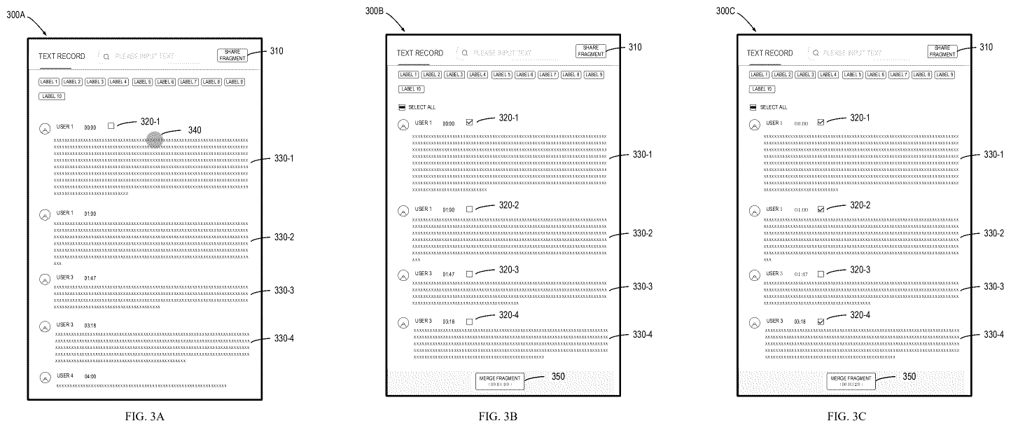

In some embodiments, the electronic device may also present the sharing portal in a graphical manner. For example, FIG. 4 illustrates a schematic diagram of an example sharing portal 400 according to some embodiments of the present disclosure.

As shown in FIG. 4, after the creation of the fragmented audiovisual content is completed, the electronic device may present the sharing portal 400. In an example, the sharing portal 400 may include description information 410 about the fragmented audiovisual content.

Taking FIG. 4 as an example, the description information 410 may include, for example, a content identifier of the fragmented audiovisual content. In some embodiments, the content identifier (also referred to as a first content identifier) of the fragmented audiovisual content may be determined based on a content identifier (also referred to as a second content identifier) of the target audiovisual content.

For example, the first content identifier may further add, on the basis of the second content identifier, an indication “fragment sharing” indicates that the content is a fragmented audiovisual content. Alternatively, the first content identifier may also include time information of the fragmented audiovisual content, for example, “00:00-04:00”.

In some embodiments, the time information may be determined based on times of the plurality of portions corresponding to the selected plurality of text fragments in the target audiovisual content. For example, the time information may indicate a time starting point for the first fragment and a time ending point for the last fragment, regardless of whether there is a skip in the middle.

In some embodiments, as shown in FIG. 4, the sharing portal 400 may further include, for example, a playback control 420 for previewing the fragmented audiovisual content. Further, the sharing portal 400 may further include a text area 430 to present the selected plurality of text fragments.

As shown in FIG. 4, the sharing portal 400 may also provide a selection regarding a sharing target. Specifically, the sharing portal 400 may include a session selection control 440 to support the user in selecting at least one user or group to share with.

In an example, the electronic device may receive at least one user or group specified by the user through the session selection control 440, and cause the fragmented audiovisual content to be shared to the selected session after selection for a sharing button 460.

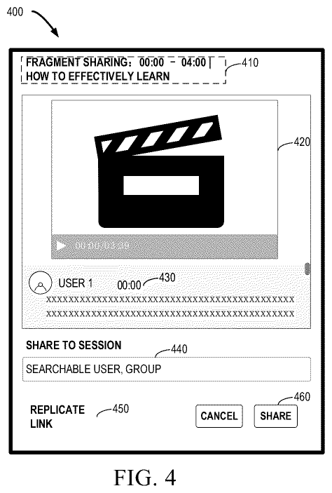

Specifically, the electronic device 400 may, for example, present sharing information corresponding to the fragmented audiovisual content in a target session window corresponding to the selected at least one user or group. FIG. 5 illustrates a schematic diagram 500 of sharing fragmented audiovisual content in a session according to some embodiments of the present disclosure.

As shown in FIG. 5, after the user selects to share the fragmented audiovisual content to “user B” through the sharing control 440, the electronic device may present the sharing information 510 in the session window with “user B”.

As shown in FIG. 5, the sharing information 510 may include, for example, description information about the fragmented audiovisual content 520, which may be, for example, the same as the description information 410. Further, the sharing information 510 may further include a playback control 530 for directly playing the fragmented audiovisual content in the target session window.

In some embodiments, the sharing information 510 also supports the user in accessing the viewing page of the fragmented audiovisual content. The viewing page for the fragmented audiovisual content will be described in detail below.

Returning to FIG. 4, the electronic device may also provide an operation option 450 in the sharing portal 400 about replicating a link. Upon receiving a selection operation on the operation option 450, the electronic device may replicate a link for accessing the fragmented audiovisual content. Such a link may be, for example, a network address of the viewing page of the fragmented audiovisual content such that the user being shared with may access the fragmented audiovisual content.

The above describes the process of creating and sharing fragmented audiovisual content based on the selection of text fragments. It can be seen that, based on this manner, the embodiments of the present disclosure can support the user to more efficiently share the fragmented audiovisual content by selecting the text fragments, thereby improving the efficiency of sharing the audiovisual content and improving the efficiency of acquiring information by the sharer. In addition, the embodiments of the present disclosure also support the user in selecting discontinuous fragments to create, which further improves the flexibility of sharing the fragmented audiovisual content.

### Viewing of Fragmented Audiovisual Content

As discussed above, the user being shared with is able to view the interface of the fragmented audiovisual content by an address of a link or sharing information (e.g., the sharing information 510).

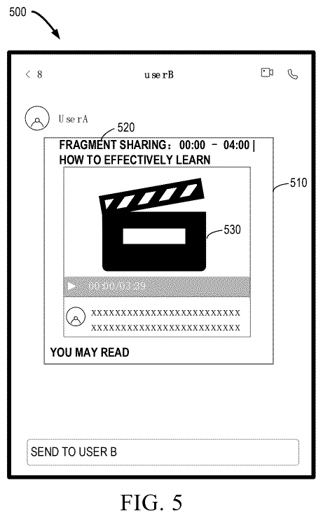

FIG. 6 illustrates a schematic diagram of a viewing interface 600 of fragmented audiovisual content according to some embodiments of the present disclosure. As shown in FIG. 6, the viewing interface 600 may be similar to the viewing interface 200A of the target audiovisual content. For example, the viewing interface 600 may include a playback control (also referred to as a playback area) for controlling play of the fragmented audiovisual content. In addition, the viewing interface 600 may include a text control (also referred to as a text area) for presenting text information corresponding to the plurality of text fragments.

In some embodiments, the interface 600 may provide a limited editing function. For example, the user of the fragmented audiovisual content may not be allowed to edit or comment text in the text control. The interface 200A may, for example, supports editing or commenting text.

In some embodiments, when the target audiovisual content is edited or its corresponding text content is edited, the text content presented by the text control of the interface 600 may vary correspondingly. For example, when a creator of the target audiovisual content edits (e.g., adds, deletes, or modifies) the text fragment (e.g., the speaking text of user 1 at 00:00), the text control in the interface 600 may also vary correspondingly according to the editing operation.

In an example, the text in the text control of the fragmented audiovisual content may be presented based on the text and fragment time offset corresponding to the target audiovisual content, where the fragment time offset may indicate the time offset of a portion corresponding to the corresponding text fragment relative to the target audiovisual file. Therefore, if the text corresponding to the target audiovisual content is edited, the text in the text control of the fragmented audiovisual content will also be updated correspondingly. In this way, the text content of the fragmented audiovisual content can be prevented from being repeatedly stored, thereby improving the storage efficiency.

In some embodiments, the interface 600 may, for example, also provide an indication on whether the fragmented audiovisual content is continuous in the target audiovisual content. For example, for a fragmented audiovisual content created based on a discontinuous fragment, the interface 600 may associate and present a label such as “discontinuous” to indicate that the fragmented audiovisual content is discontinuous in the target audiovisual content. As another example, for a fragmented audiovisual content created based on a continuous fragment, the interface 600 may associate and present a label such as “continuous” to indicate that the fragmented audiovisual content is continuous in the target audiovisual content.

In some embodiments, as shown in FIG. 6, different from the viewing interface 200A of the target audiovisual file, a text label may not be provided in the text control of the interface 600.

Alternatively, the text control of the interface 600 may also provide the same text label as the text label in the viewing interface 200A of the target audiovisual file. Such a text label may be automatically generated based on the analysis of the text content of the target audiovisual file.

Alternatively, the text control of the interface 600 may also provide different text labels than the text labels in the viewing interface 200A of the target audiovisual file. The text labels provided in the interface 600 may be automatically generated, for example, based on analysis of text content related to the fragmented audiovisual file.

In some embodiments, as shown in FIG. 6, the interface 600 may, for example, provide an option 610 for accessing the target audiovisual content, so that the user may view the target audiovisual content corresponding to the fragmented audiovisual content.

In some embodiments, the interface 600 may also provide an option 620 for deleting the fragmented audiovisual content. For example, when the user accessing the interface 600 is a creator of the fragmented audiovisual content or a manager (e.g., the owner) of the target audiovisual content, the interface 600 may include an option 620 to allow the creator or the manager of the target audiovisual content to directly delete the fragmented audiovisual content.

In some embodiments, interface 600, for example, also allows an option 630 for sharing the fragmented audiovisual content to share the fragmented audiovisual content to other users or groups, or replicate the links to the clipboard.

### Right For Fragmented Audiovisual Content

The creation, sharing and viewing of the fragmented audiovisual content are described above. In some embodiments, the fragmented audiovisual content may, for example, possess a separate right control mechanism.

In some embodiments, the manager of the target audiovisual content may, for example, specify a fragmented right mechanism of the target audiovisual content. For example, the manager may specify that users with reading right for the target audiovisual content will be allowed to create fragmented audiovisual content based on the target audiovisual content.

Alternatively, the manager may also specify that users with editing right for the target audiovisual content will be allowed to create fragmented audiovisual content based on the target audiovisual content. Alternatively, the manager may also specify that only he or she has the right to create fragmented audiovisual content based on the target audiovisual content.

In some embodiments, when other users create fragmented audiovisual content based on the target audiovisual content, a manage user associated with the target audiovisual content may receive a notification that the fragmented audiovisual content is created.

In some embodiments, viewing access of the fragmented audiovisual content may be determined, for example, based on access rights of the target audiovisual content. For example, only a user with viewing right of the target audiovisual content can view the fragmented audiovisual content.

Alternatively, considering that the fragmented audiovisual content may provide limited editing right and the right of the fragmented audiovisual content may also be set independently. For example, the access right of the fragmented audiovisual content may be based on, for example, organizational information (for example, a company, a part, a development group, or the like) of a creator that creates the fragmented audiovisual content, so that other users or groups in the same organization as the creator can access the fragmented audiovisual content.

Alternatively, the access right of the fragmented audiovisual content may, for example, be opened by default to all users who obtain the access link, so that the user who obtains the access link is always able to access the fragmented audiovisual content.

### Management of Fragmented Audiovisual Content

In some embodiments, embodiments of the present disclosure may also support management of the created fragmented audiovisual content.

In some embodiments, the manager of the target audiovisual content can manage the fragmented audiovisual content created based on the target audiovisual content through the viewing interface of the target audiovisual content. For example, when the manager accesses the viewing interface (for example, the interface 200A) of the target audiovisual content, the manager may manage all the fragmented audiovisual content created based on the target audiovisual content by a “fragment management” option as shown in FIG. 2A.

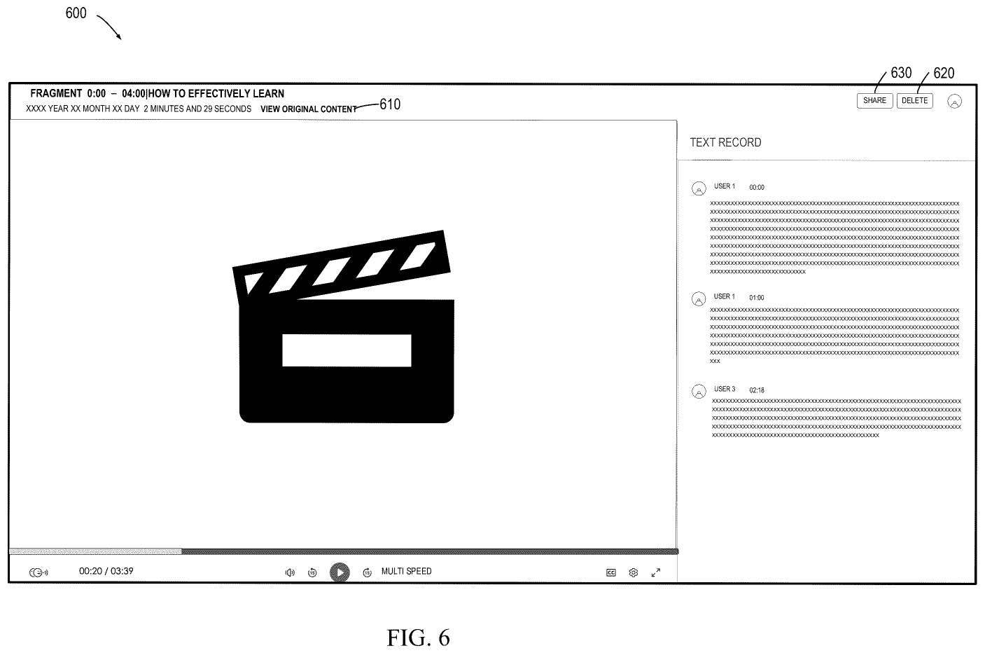

FIG. 7 illustrates a schematic diagram of a management interface 700 of fragmented audiovisual content according to some embodiments of the present disclosure. For example, the management interface 700 corresponding to the manager may be presented or generated after the manager clicks the “fragment management” option.

As shown in FIG. 7, the management interface 700 may include, for example, a control 710 for setting rights for creating the fragmented audiovisual content based on the target audiovisual content. For example, the currently set right is “users with reading rights may create fragments”.

In addition, the management interface 700 may further include a fragment list, which may include, for example, description information of at least one fragmented audiovisual content created based on the target audiovisual content. Taking FIG. 7 as an example, the fragment list may include fragmented audiovisual content 720, and its corresponding description information 730 may include, for example, creation information such as “creator: user A”. The description information may also include, for example, duration information such as “3 minutes and 39 seconds”. In addition, the description information 730 may further include sharing information, for example, “the number of visitors: 80”. Such description information may help the manager understand the creation and sharing conditions of the created fragmented audiovisual content.

In some embodiments, the management interface 700 may also include a sharing option 740 for sharing the fragmented audiovisual content 720 to, for example, share to other users/organizations or replicate links. Alternatively, the management interface 700 may further include a deleting control 740 for deleting the fragmented audiovisual content 720.

In this way, the manager of the target audiovisual content can more conveniently know the creation and sharing conditions of the relevant fragmented audiovisual content, and can quickly perform operations such as sharing or deleting.

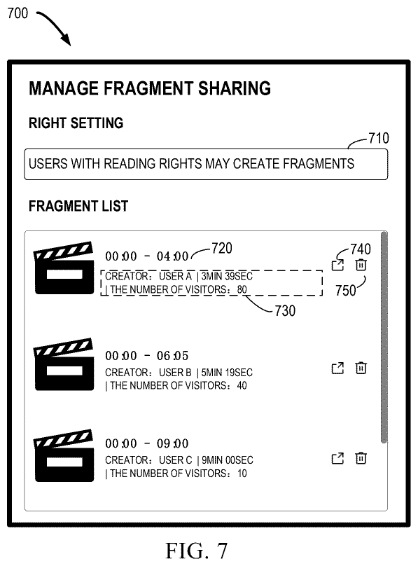

In some embodiments, embodiments of the present disclosure also enable the creator of the fragmented audiovisual content to efficiently manage the created one or more fragmented audiovisual content. For example, FIG. 8 is a schematic diagram of a management interface 800 of fragmented audiovisual content according to other embodiments of the present disclosure.

As shown in FIG. 8, the management interface 800 may be, for example, an interface corresponding to a creator, to manage the created one or more fragmented audiovisual content. For example, the management interface 800 may include, for example, a searching control 810 to allow the creator to quickly view the created fragmented audiovisual content based on the identifier of the fragmented audiovisual content, the creation time, the identification of the original audiovisual content, and the like.

In addition, the management interface 800 may also include, for example, a fragment list to provide information of at least one fragmented audiovisual content created by the creator. For example, the fragment list may include description information about the fragmented audiovisual content 820. The description information 830 may include, for example, duration information and/or sharing information.

Alternatively, or additionally, the management interface 800 may also include a sharing option 840 for sharing the fragmented audiovisual content 820 to, for example, share to other users/organizations or replicate links. Alternatively, the management interface 800 may further include a deleting control 840 for deleting the fragmented audiovisual content 820.

In this way, the manager of the target audio-visual content can more conveniently know the condition of the created fragmented audiovisual content and can quickly perform operations such as sharing or deleting.

### EXAMPLE PROCESSES

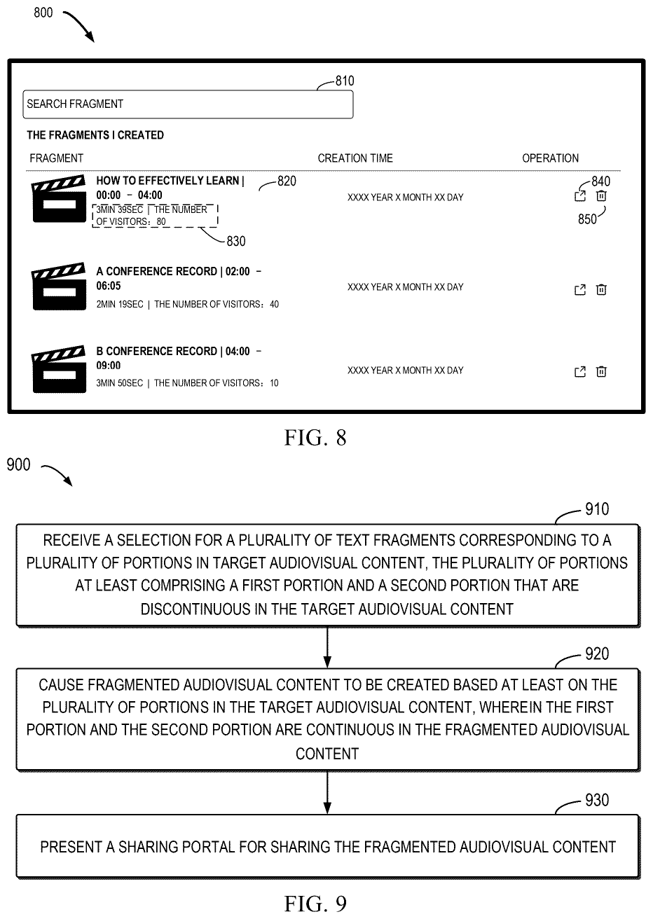

FIG. 9 illustrates a flowchart of an example process 900 for sharing audiovisual content according to some embodiments of the present disclosure. The process 900 may be implemented at appropriate electronic devices. Examples of such electronic devices may include, but are not limited to, desktop computers, laptop computers, smart phones, tablet computers, personal digital assistants or smart wearable devices, and the like.

As shown in FIG. 9, at block 910, the electronic device receives a selection for a plurality of text fragments corresponding to a plurality of portions in target audiovisual content, the plurality of portions at least comprising a first portion and a second portion that are discontinuous in the target audiovisual content.

At block 920, the electronic device causes fragmented audiovisual content to be created based at least on the plurality of portions in the target audiovisual content, wherein the first portion and the second portion are continuous in the fragmented audiovisual content.

At block 930, the electronic device presents a sharing portal for sharing the fragmented audiovisual content.

In some embodiments, the method further includes causing a first viewing interface associated with the fragmented audiovisual content to be generated, the first viewing interface comprising a first area for controlling playback of the fragmented audiovisual content and a second area for presenting text information corresponding to the plurality of text fragments.

In some embodiments, the text information presented in the second area varies in response to an editing operation for the target audiovisual content and/or a text corresponding to the target audiovisual content.

In some embodiments, receiving the selection for the plurality of text fragments comprises: presenting a plurality of selection controls corresponding to the plurality of text fragments; and receiving the selection for the plurality of text fragments based on an interaction for the plurality of selection controls.

In some embodiments, presenting the plurality of selection controls corresponding to the plurality of text fragments comprises: presenting a sharing control; and in response to a selection for the sharing control, presenting the plurality of selection controls corresponding to the plurality of text fragments.

In some embodiments, presenting the plurality of selection controls corresponding to the plurality of text fragments comprises: in response to a selection operation for a target text fragment in the plurality of text fragments, presenting a target selection control corresponding to the target text fragment; and in response to the target selection control being selected, presenting the plurality of selection controls corresponding to the plurality of text fragments.

In some embodiments, causing the fragmented audiovisual content to be created based at least on the plurality of portions in the target audiovisual content comprises: presenting a fragment time length, the fragment time length being determined based on time lengths of the plurality of portions; and in response to the time length being less than a threshold length, causing the fragmented audiovisual content to be created based at least on the plurality of portions of the target audiovisual content.

In some embodiments, presenting the fragment time length comprises: presenting the fragment time length such that the fragment time length is updated in response to selection or deselection for a text fragment; or in response to an acknowledgement of the selection for the plurality of text fragments, presenting the fragment time length.

In some embodiments, causing the fragmented audiovisual content to be created based at least on the plurality of portions in the target audiovisual content comprises: sending merge time information to a merge device, to cause the merging device to create the fragmented audiovisual content based on the target audiovisual content and the merge time information, the merge time information indicating times of the plurality of portions in the target audiovisual content.

In some embodiments, presenting the sharing portal for sharing the fragmented audiovisual content comprises: presenting description information associated with the fragmented audiovisual content, the description information comprising at least one of: a first content identifier of the fragmented audiovisual content or time information of the fragmented audiovisual content, wherein the first content identifier is generated based on a second content identifier of the target audiovisual content, and the time information is generated based on times of the plurality of portions in the target audiovisual content.

In some embodiments, the method further includes: in response to a first sharing operation for the sharing portal, replicating a link for accessing the fragmented audiovisual content.

In some embodiments, the method further includes: in response to a second sharing operation for the sharing portal, presenting, in a target session window, sharing information corresponding to the fragmented audiovisual content, the second sharing operation indicating at least one user or group to share with.

In some embodiments, the sharing information comprises a playback control, and the playback control is configured to play the fragmented audiovisual content in the target session window.

In some embodiments, the method further includes: in response to the fragmented audiovisual content being created, causing a manage user associated with the target audiovisual content to receive a notification of the fragmented audiovisual content being created.

In some embodiments, a first access right to the fragmented audiovisual content is determined based on: a second access right to the target audiovisual content; and/or organization information of a creator that creates the fragmented audiovisual content.

In some embodiments, the creator has at least reading rights for the target audiovisual content.

In some embodiments, the method further includes: causing a first management interface associated with the target audiovisual content to be generated, the first management interface corresponding to a manage user of the target audiovisual content, wherein the first management interface comprises a first fragment list comprising description information of at least one fragmented audiovisual content created based on the target audiovisual content.

In some embodiments, the first management interface further includes a deleting control for deleting at least one fragmented audiovisual content.

In some embodiments, the description information includes at least one of the following information: creation information, duration information, sharing information, and access information.

In some embodiments, the method further includes: causing a second management interface associated with the fragmented audiovisual content to be generated, the second management interface corresponding to a creator of the fragmented audiovisual content, wherein the second management interface comprises a second fragment list comprising description information of at least one fragmented audiovisual content created by the creator.

In some embodiments, receiving the selection for the plurality of text fragments comprises: presenting a text interaction component, the text interaction component providing a set of text fragments and corresponding audio object information, the set of text fragments being generated based on audio information of the target audiovisual content, and the audio object information indicating a speaker associated with a text fragment; and receiving the selection for the plurality of text fragments in the text interaction component.

In some embodiments, receiving the selection for the plurality of text fragments in the set of text fragments comprises: receiving an input indicating a target speaker; and determining, based on the input, at least one text fragment associated with the target speaker to be selected.

In some embodiments, the method further includes: causing a second viewing interface of the target audiovisual content to be generated, the first viewing interface comprising a third area for controlling playback of the target audiovisual content and a fourth area for presenting a set of text fragments associated with the target audiovisual content, and the set of text fragments being generated based on audio information of the target audiovisual content.

In some embodiments, the plurality of text fragments are generated based on audio information of the target audiovisual content.

### EXAMPLE APPARATUS AND DEVICES

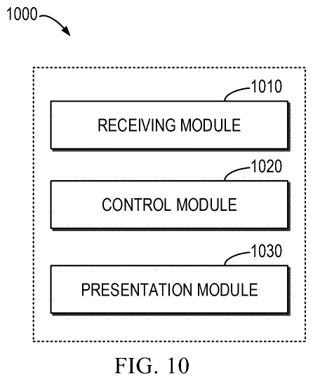

Embodiments of the present disclosure further provide a corresponding apparatus for implementing the above method or process. FIG. 10 illustrates a schematic structural block diagram of an apparatus 1000 for sharing audiovisual content according to some embodiments of the present disclosure.

As shown in FIG. 10, the apparatus 1000 includes a receiving module 1010 configured to receive a selection for a plurality of text fragments corresponding to a plurality of portions in a target audiovisual content, the plurality of portions at least comprising a first portion and a second portion that are discontinuous in the target audiovisual content.

The apparatus 1000 further includes a control module 1020 configured to cause fragmented audiovisual content to be created based at least on the plurality of portions in the target audiovisual content, wherein the first portion and the second portion are continuous in the fragmented audiovisual content.

In addition, the apparatus 1000 further includes a presentation module 1030 configured to present a sharing portal for sharing the fragmented audiovisual content.

In some embodiments, the control module 1020 is further configured to cause a first viewing interface associated with the fragmented audiovisual content to be generated, the first viewing interface comprising a first area for controlling playback of the fragmented audiovisual content and a second area for presenting text information corresponding to the plurality of text fragments.

In some embodiments, the text information presented in the second area varies in response to an editing operation for the target audiovisual content and/or a text corresponding to the target audiovisual content.

In some embodiments, the receiving module 1010 is further configured to: present a plurality of selection controls corresponding to the plurality of text fragments; and receive the selection for the plurality of text fragments based on an interaction for the plurality of selection controls.

In some embodiments, the presentation module 1030 is further configured to, present a sharing control; and in response to a selection for the sharing control, present the plurality of selection controls corresponding to the plurality of text fragments.

In some embodiments, the presenting module 1030 is further configured to, in response to a selection operation for a target text fragment in the plurality of text fragments, present a target selection control corresponding to the target text fragment; and in response to the target selection control being selected, present the plurality of selection controls corresponding to the plurality of text fragments.

In some embodiments, the control module 1020 is further configured to: present a fragment time length, the fragment time length being determined based on time lengths of the plurality of portions; and in response to the time length being less than a threshold length, cause the fragmented audiovisual content to be created based at least on the plurality of portions of the target audiovisual content.

In some embodiments, the control module 1020 is further configured to: the fragment time length such that the fragment time length is updated in response to selection or deselection for a text fragment; or in response to an acknowledgement of the selection for the plurality of text fragments, present the fragment time length.

In some embodiments, the control module 1020 is further configured to: send merge time information to a merge device, to cause the merging device to create the fragmented audiovisual content based on the target audiovisual content and the merge time information, the merge time information indicating times of the plurality of portions in the target audiovisual content.

In some embodiments, the presentation module 1030 is further configured to: present description information associated with the fragmented audiovisual content, the description information comprising at least one of: a first content identifier of the fragmented audiovisual content or time information of the fragmented audiovisual content, wherein the first content identifier is generated based on a second content identifier of the target audiovisual content, and the time information is generated based on times of the plurality of portions in the target audiovisual content.

In some embodiments, the apparatus 1000 further includes a sharing module configured to, in response to a first sharing operation for the sharing portal, replicate a link for accessing the fragmented audiovisual content.

In some embodiments, the sharing module is further configured to, in response to a second sharing operation for the sharing portal, present, in a target session window, sharing information corresponding to the fragmented audiovisual content, the second sharing operation indicating at least one user or group to share with.

In some embodiments, the sharing information comprises a playback control, and the playback control is configured to play the fragmented audiovisual content in the target session window.

In some embodiments, the apparatus 1000 further includes a notification module configured to, in response to the fragmented audiovisual content being created, causing a manage user associated with the target audiovisual content to receive a notification of the fragmented audiovisual content being created.

In some embodiments, a first access right to the fragmented audiovisual content is determined based on: a second access right to the target audiovisual content; and/or organization information of a creator that creates the fragmented audiovisual content.

In some embodiments, the creator has at least reading rights for the target audiovisual content.

In some embodiments, the control module 1020 is further configured to: cause a first management interface associated with the target audiovisual content to be generated, the first management interface corresponding to a manage user of the target audiovisual content, wherein the first management interface comprises a first fragment list comprising description information of at least one fragmented audiovisual content created based on the target audiovisual content.

In some embodiments, the first management interface further includes a deleting control for deleting at least one fragmented audiovisual content.

In some embodiments, the description information includes at least one of the following information: creation information, duration information, sharing information, and access information.

In some embodiments, the control module 1020 is further configured to cause a second management interface associated with the fragmented audiovisual content to be generated, the second management interface corresponding to a creator of the fragmented audiovisual content, wherein the second management interface comprises a second fragment list comprising description information of at least one fragmented audiovisual content created by the creator.

In some embodiments, the receiving module 1010 is further configured to: present a text interaction component, the text interaction component providing a set of text fragments and corresponding audio object information, the set of text fragments being generated based on audio information of the target audiovisual content, and the audio object information indicating a speaker associated with a text fragment; and receive the selection for the plurality of text fragments in the text interaction component.

In some embodiments, the receiving module 1010 is further configured to: receive an input indicating a target speaker; and determine, based on the input, at least one text fragment associated with the target speaker to be selected.

In some embodiments, the control module 1020 is further configured to cause a second viewing interface of the target audiovisual content to be generated, the first viewing interface comprising a third area for controlling playback of the target audiovisual content and a fourth area for presenting a set of text fragments associated with the target audiovisual content, and the set of text fragments being generated based on audio information of the target audiovisual content.

In some embodiments, the plurality of text fragments are generated based on audio information of the target audiovisual content.

The units included in the apparatus 1000 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 1000 may be implemented, at least in part, by one or more hardware logic components. By an example rather than a limitation, example types of hardware logic components that may be used include field programmable gate array (FPGA), application specific integrated circuits (ASIC), application specific standards (ASSP), system-on-a-chip (SOC), complex programmable logic devices (CPLD), and the like.

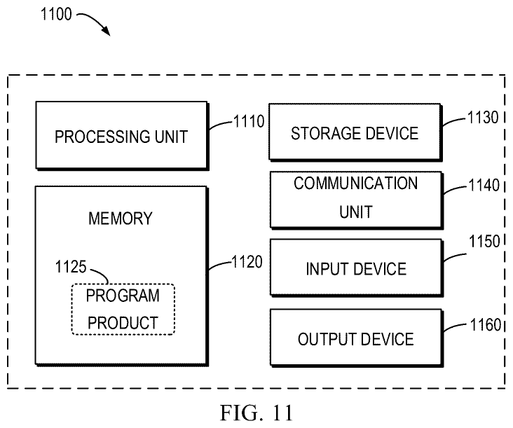

FIG. 11 illustrates a block diagram of a computing device/server 1100 in which one or more embodiments of the present disclosure may be implemented. It should be understood that the computing device/server 1100 illustrated in FIG. 11 is merely an example and should not constitute any limitation on the functionality and scope of the embodiments described herein.

As shown in FIG. 11, the computing device/server 1100 is in the form of a general-purpose computing device. Components of the computing device/server 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In a multiprocessor system, multiple processing units execute computer-executable instructions in parallel to improve the parallel processing capability of the computing device/server 1100.

The computing device/server 1100 typically includes a plurality of computer storage medium. Such medium may be any available medium accessible by the computing device/server 1100, including, but not limited to, volatile and non-volatile medium, removable and non-removable medium. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 1130 may be a removable or non-removable medium and may include a machine-readable medium, such as a flash drive, magnetic disk, or any other medium, which may be capable of storing information and/or data (e.g., training data for training) and may be accessed within computing device/server 1100.

The computing device/server 1100 may further include additional removable/non-removable, volatile/non-volatile storage media. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data medium interface. The memory 1120 may include a computer program product 1125 having one or more program modules configured to perform various methods or actions of various embodiments of the present disclosure.

The communications unit 1140 implements communications with other computing devices over a communications medium. Additionally, the functionality of components of the computing device/server 1100 may be implemented in a single computing cluster or multiple computing machines capable of communicating over a communication connection. Therefore, the computing device/server 1100 may operate in a networked environment using logical connections with one or more other servers, network personal computers (PCs), or another network node.

The input device 1150 may be one or more input devices such as a mouse, a keyboard, a trackball, or the like. The output device 1160 may be one or more output devices, such as a display, a speaker, a printer, or the like. The computing device/server 1100 may also communicate with one or more external devices (not shown) such as storage devices, display devices, etc. as needed, communicate with one or more devices that enable a user to interact with the computing device/server 1100, or communicate with any device (e.g., network card, modem, etc.) that enables computing device/server 1100 to communicate with one or more other computing devices. Such communication may be performed via an input/output (I/O) interface (not shown).

According to example implementations of the present disclosure, there is provided a computer-readable storage medium having one or more computer instructions stored thereon, wherein one or more computer instructions are executed by a processor to implement the method described above.

Aspects of the present disclosure are described herein with reference to flowcharts and/or block diagrams of methods, apparatuses (systems), and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatuses to produce a machine, such that the instructions, when executed by a processing unit of a computer or other programmable data processing apparatuses, produce apparatuses to implement the functions/acts specified in the flowchart and/or block diagram. These computer-readable program instructions may also be stored in a computer-readable storage medium that cause the computer, programmable data processing apparatuses, and/or other devices to work in a particular manner, such that the computer-readable medium storing instructions includes an article of manufacture including instructions to implement aspects of the functions/acts specified in the flowchart and/or block diagram(s).

The computer-readable program instructions may also be loaded onto a computer, other programmable data processing apparatus, or other devices, such that a series of operation steps are performed on a computer, other programmable data processing apparatuses, or other devices to produce a computer-implemented process such that the instructions executed on a computer, other programmable data processing apparatuses, or other devices implement the functions/acts specified in the flowchart and/or block diagram block or blocks.

The flowchart and block diagrams in the drawings show architecture, functionality, and operation of possible implementations of systems, methods, and computer program products according to various implementations of the present disclosure. In this regard, each block in the flowchart or block diagram may represent a module, program fragment, or portion of an instruction that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the implementations disclosed herein.

1. A method of sharing audiovisual content, comprising:
receiving a selection for a plurality of text fragments corresponding to a plurality of portions in target audiovisual content, the plurality of portions at least comprising a first portion and a second portion that are discontinuous in the target audiovisual content;
causing fragmented audiovisual content to be created based at least on the plurality of portions in the target audiovisual content, wherein the first portion and the second portion are continuous in the fragmented audiovisual content; and
presenting a sharing portal for sharing the fragmented audiovisual content.

2. The method of claim 1, further comprising:
causing a first viewing interface associated with the fragmented audiovisual content to be generated, the first viewing interface comprising a first area for controlling playback of the fragmented audiovisual content and a second area for presenting text information corresponding to the plurality of text fragments.

3. The method of claim 2, wherein the text information presented in the second area varies in response to an editing operation for the target audiovisual content and/or a text corresponding to the target audiovisual content.

4. The method of claim 1, wherein receiving the selection for the plurality of text fragments comprises:
presenting a plurality of selection controls corresponding to the plurality of text fragments; and
receiving the selection for the plurality of text fragments based on an interaction for the plurality of selection controls.

5. The method of claim 4, wherein presenting the plurality of selection controls corresponding to the plurality of text fragments comprises:
presenting a sharing control; and in response to a selection for the sharing control, presenting the plurality of selection controls corresponding to the plurality of text fragments; or
in response to a selection operation for a target text fragment in the plurality of text fragments, presenting a target selection control corresponding to the target text fragment; and in response to the target selection control being selected, presenting the plurality of selection controls corresponding to the plurality of text fragments.

6. The method of claim 1, wherein causing the fragmented audiovisual content to be created based at least on the plurality of portions in the target audiovisual content comprises:
presenting a fragment time length, the fragment time length being determined based on time lengths of the plurality of portions; and
in response to the time length being less than a threshold length, causing the fragmented audiovisual content to be created based at least on the plurality of portions of the target audiovisual content.

7. The method of claim 6, wherein presenting the fragment time length comprises:
presenting the fragment time length such that the fragment time length is updated in response to selection or deselection for a text fragment; or
in response to an acknowledgement of the selection for the plurality of text fragments, presenting the fragment time length.

8. The method of claim 1, wherein causing the fragmented audiovisual content to be created based at least on the plurality of portions in the target audiovisual content comprises:
sending merge time information to a merge device, to cause the merging device to create the fragmented audiovisual content based on the target audiovisual content and the merge time information, the merge time information indicating times of the plurality of portions in the target audiovisual content.

9. The method of claim 1, wherein presenting the sharing portal for sharing the fragmented audiovisual content comprises:
presenting description information associated with the fragmented audiovisual content, the description information comprising at least one of: a first content identifier of the fragmented audiovisual content or time information of the fragmented audiovisual content,
wherein the first content identifier is generated based on a second content identifier of the target audiovisual content, and the time information is generated based on times of the plurality of portions in the target audiovisual content.

10. The method of claim 1, further comprising:
in response to a first sharing operation for the sharing portal, replicating a link for accessing the fragmented audiovisual content.

11. The method of claim 1, further comprising:
in response to a second sharing operation for the sharing portal, presenting, in a target session window, sharing information corresponding to the fragmented audiovisual content, the second sharing operation indicating at least one user or group to share with.

12. The method of claim 11, wherein the sharing information comprises a playback control, and the playback control is configured to play the fragmented audiovisual content in the target session window.

13. The method of claim 1, further comprising:
in response to the fragmented audiovisual content being created, causing a manage user associated with the target audiovisual content to receive a notification of the fragmented audiovisual content being created.

14. The method of claim 1, wherein a first access right to the fragmented audiovisual content is determined based on at least one of:
a second access right to the target audiovisual content; or
organization information of a creator that creates the fragmented audiovisual content.

15. The method of claim 1, further comprising:
causing a first management interface associated with the target audiovisual content to be generated, the first management interface corresponding to a manage user of the target audiovisual content, wherein the first management interface comprises a first fragment list comprising description information of at least one fragmented audiovisual content created based on the target audiovisual content.

16. The method of claim 1, further comprising:
causing a second management interface associated with the fragmented audiovisual content to be generated, the second management interface corresponding to a creator of the fragmented audiovisual content, wherein the second management interface comprises a second fragment list comprising description information of at least one fragmented audiovisual content created by the creator; and/or
causing a second viewing interface of the target audiovisual content to be generated, the second viewing interface comprising a third area for controlling playback of the target audiovisual content and a fourth area for presenting a set of text fragments associated with the target audiovisual content, and the set of text fragments being generated based on audio information of the target audiovisual content.

17. The method of claim 1, wherein receiving the selection for the plurality of text fragments comprises:
presenting a text interaction component, the text interaction component providing a set of text fragments and corresponding audio object information, the set of text fragments being generated based on audio information of the target audiovisual content, and the audio object information indicating a speaker associated with a text fragment; and
receiving the selection for the plurality of text fragments in the text interaction component.

18. The method of claim 17, wherein receiving the selection for the plurality of text fragments in the set of text fragments comprises:
receiving an input indicating a target speaker; and
determining, based on the input, at least one text fragment associated with the target speaker to be selected.

19. (canceled)

20. (canceled)

21. (canceled)

22. An electronic device comprising:
at least one processing unit; and
at least one memory coupled to the at least one processing unit and storing instructions for execution by the at least one processing unit, the instructions, when executed by the at least one processing unit, causing the electronic device to perform operations comprising:
receiving a selection for a plurality of text fragments corresponding to a plurality of portions in target audiovisual content, the plurality of portions at least comprising a first portion and a second portion that are discontinuous in the target audiovisual content;
causing fragmented audiovisual content to be created based at least on the plurality of portions in the target audiovisual content, wherein the first portion and the second portion are continuous in the fragmented audiovisual content; and
presenting a sharing portal for sharing the fragmented audiovisual content.

23. A non-transitory computer-readable storage medium having a computer program stored thereon, which when executed by a processor, implements operations comprising:
receiving a selection for a plurality of text fragments corresponding to a plurality of portions in target audiovisual content, the plurality of portions at least comprising a first portion and a second portion that are discontinuous in the target audiovisual content;
causing fragmented audiovisual content to be created based at least on the plurality of portions in the target audiovisual content, wherein the first portion and the second portion are continuous in the fragmented audiovisual content; and
presenting a sharing portal for sharing the fragmented audiovisual content.
